(19) United States
(12) Patent Application Publication
(10) Pub. No.: US 2008/0116340 A1
(43) Pub. Date: May 22, 2008

(54) OPTIC SUPPORT ARM

(76) Inventor: JAMES DAVID GREENE, ODESSA, TX (US)

Correspondence Address: WOOD AND EISENBERG, PLLC, 6911 RICHMOND HIGHWAY, SUITE 403, Alexandria, VA, 22306, US

(21) Appl. No.: 11/782,586

(22) Filed: Jul. 24, 2007

Related U.S. Application Data
(60) Provisional application No. 60/866,854, filed on Nov. 21, 2006.

(51) Int. Cl. F16M 11/00

(52) U.S. Cl. 248/229.15

(57) ABSTRACT

An optic support arm, which in one aspect of the invention comprises: a main support bracket having a first end and a second end, a follower guide post having a threaded bore therethrough, an elongated threaded member in threaded engagement with the threaded bore of the follower guide post, such that rotation of the threaded member causes linear movement of the threaded member relative to the main support bracket, a follower member connected at one end of the threaded member, and carried by the threaded member during linear movement of the threaded member in a direction toward or away from the first end of the main support bracket for releasably engaging a support member between the follower member and the first end of the main support bracket, a connecting member releasably connectable to the second end of the main support bracket, and a mounting mechanism supported by the connecting member.

### CROSS REFERENCE TO RELATED APPLICATIONS

Priority is hereby claimed of co-pending Provisional Patent Application No. 60/866,854 filed on Nov. 21, 2006, entitled Optic Support Arm.

### STATEMENT REGARDING FEDERALLY SPONSORED RESEARCH OR DEVELOPMENT

Not applicable.

### FIELD OF THE INVENTION

The present invention relates to optic support devices.

### BACKGROUND OF THE INVENTION

There are many occasions when, for example, an outdoorsman or outdoorswoman needs assistance to hold, for example, a spotting or optical scope and/or camera steady while observing wildlife such as deer or birds. This is especially true where the camera is a video camera that must remain aimed at a fixed point for an extended period of time.

Deer blinds are used to hunt deer or otherwise observe wildlife. A deer hunter, animal watcher, or bird watcher sitting in a deer blind will typically make extensive use of a spotting scope or a camera. To use such a spotting scope or camera effectively requires a steady hand or other means for holding the spotting scope or camera steady. The terms “optical scope”, “spotter scope”, and “spotting scope” are hereinafter regarded as equivalent terms.

For example, a deer hunter may wish to hold a beverage or other object in one or both hands, while still using a spotter scope or other optic device such as a still camera or video camera. Additionally, there are occasions when a camera must be fixed to an outdoor carrier such as a pickup truck or a motorboat, and where the camera must be aimed and fixed so that a person need not hold it. It is accordingly a problem in the art to provide a device or apparatus to support and aim a still camera, video camera, spotting scope, or other device without requiring manual support.

Further, the space inside a hunting blind is limited, and if a standard camera tripod were to be used, it would require a substantial amount of the interior space of the hunting blind. Similarly, if a standard camera tripod were used in a pickup truck bed, or in the interior of a boat, it would require a substantial amount of the interior space. Therefore, it is a problem in the art to provide a device or apparatus to support and aim a still camera, video camera, spotting scope, or other device without using the interior floor space of a hunting blind, a pickup truck bed, or a boat.

U.S. Pat. No. 5,347,740 to Rather et al describes a multi-functional and variable position camera mount, suitable for rigid attachment to a stand or vehicle, and includes a movable mechanism to allow the user to comfortably aim and rapidly lock the camera in any one of many positions. A clamp with a threaded thumb screw allows for the clamp to be moved easily and be fastened rigidly to a rail such as found in a deer blind, or to be also installed on a vehicle.

In U.S. Patent Application No. 20030122045 to Mulford et al, a mount is described for a visual recording device for attachment to a hunting structure such as a deer stand or duck blind. The mount kit includes a C-shaped clamp and various base members with pan and tilt mechanisms, for supporting the visual recording device.

Also, U.S. Pat. No. 5,664,750 to Cohen shows a removable, attached base clamp to engage an environmental support. An adapter is attached to the base and is designed to receive mast portions, increasing the possible angles at which the mast can be set relative to the base clamp. It is adapted to accommodate the field of view of the camera, and aid in concealment.

In U.S. Pat. No. 6,729,592 to Kurtts, a support is shown for an optical device which includes a vertically and horizontally adjustable leveling device. An L-shaped adjustable clamp has a self securing clamping knob, and is used to secure the device in a variety of positions.

### SUMMARY OF THE INVENTION

An optic support arm, which in one aspect of the invention comprises: a main support bracket having a first end and a second end, a follower guide post having a threaded bore therethrough, an elongated threaded member in threaded engagement with the threaded bore of the follower guide post, such that rotation of the threaded member causes linear movement of the threaded member relative to the main support bracket, a follower member connected at one end of the threaded member, and carried by the threaded member during linear movement of the threaded member in a direction toward or away from the first end of the main support bracket for releasably engaging a support member between the follower member and the first end of the main support bracket, a connecting member releasably connectable to the second end of the main support bracket, and a mounting mechanism supported by the connecting member.

### BRIEF DESCRIPTION OF THE DRAWINGS

FIG. 1 is an environmental perspective view of an optic support arm according to the present invention, supporting a spotting scope shown in phantom outline.

FIG. 2 is an environmental perspective view of an optic support arm according to the present invention, supporting a camera shown in phantom outline.

FIG. 3 is an assembly view of the optic support arm of FIG. 1, the pan-and-tilt mechanism and its supporting U-shaped connecting member separated from the main support bracket.

FIG. 4 is an environmental perspective view of the optic support arm of FIG. 3 in an assembled condition, and showing the two mutually perpendicular axes of rotation of the pan-and-tilt mechanism.

FIG. 5 is an environmental perspective view of the optic support arm of FIG. 4, depicting the pan-and-tilt mechanism in a slightly changed position, and showing the follower member in a more closed position as when secured to a frame member.

FIG. 6 is an environmental perspective view of the optic support arm of FIG. 4, from a direction showing another side of the pan-and-tilt mechanism in which a manually operable thumbwheel is shown.

FIG. 7 is a schematic side view, partially in section, depicting securement of the follower member to the threaded member by retaining members on opposite sides of the follower member.

FIG. 8 is a schematic side view depicting the operation of a securement plate of the U-shaped connecting member for securing the U-shaped connecting member to the second end of the main support bracket.

### DETAILED DESCRIPTION OF THE INVENTION

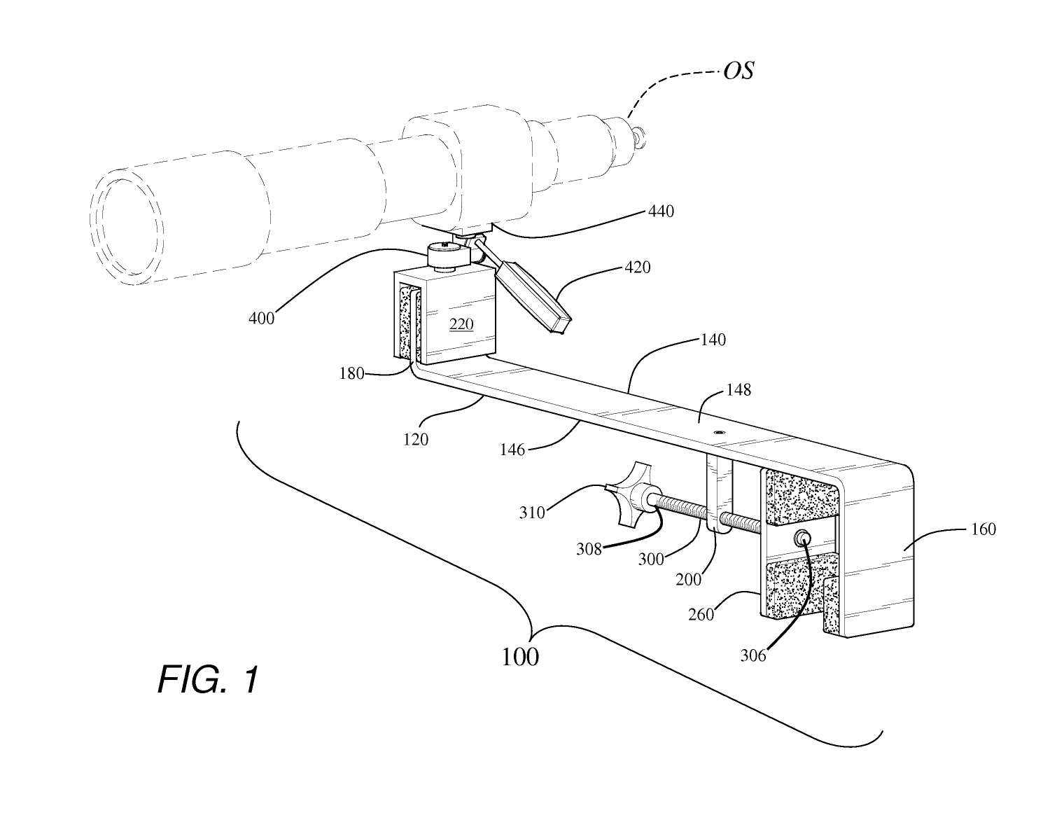

FIG. 1 is an environmental perspective view of an optic support arm 100, which is shown supporting a spotting scope OS shown in phantom outline. The optic support arm 100 comprises a main support bracket 120 having first 160 and second 180 opposite ends and an intermediate support portion 140 therebetween. The first end 160 defines a first L-shaped bracket facing downwards in the vertical plane and the second end 180 defines a second L-shaped bracket facing upwards in the vertical plane. The intermediate support portion 140 defines a generally elongated planar structure in the horizontal plane with lower and upper surfaces 146 and 148, respectively.

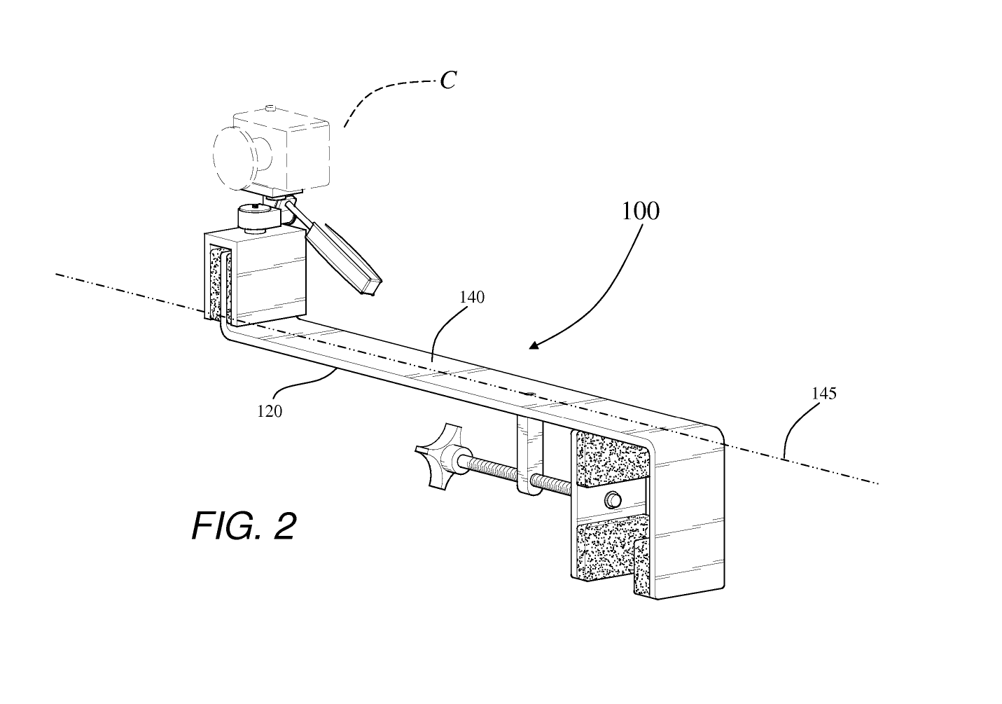

A follower guide post 200 is attached to the main support bracket 120 and more particularly to the lower surface 146 of the intermediate support portion 140 by a screw member (unnumbered) as shown in FIG. 1, or can be welded or glued thereto. The follower guide post 200 is shown set in a perpendicular plane with respect to the lower surface 146 of the intermediate support portion 140. The follower guide post 200 can be formed integrally with the main support bracket 120, for example if the parts are molded from plastic or formed by casting. The follower guide post 200 has a threaded bore therethrough to permit passage of an elongated threaded member 300 in threaded lo engagement therewith, so that rotation of the threaded member 300 causes linear movement of the threaded member 300 relative to the main support bracket 120 and more particularly the intermediate support portion 140, and still more particularly the long axis 145 (shown in FIG. 2) of the intermediate support portion 140, which forms part of the main support bracket 120. In one aspect of the invention the threaded member 300 causes parallel linear movement of the threaded member 300 relative to the intermediate support portion 140. The threaded member 300 defines free end 306 and opposite end 308.

A U-shaped connecting member 220 is removably attached to the second end 180 of the main support bracket 120. The U-shaped connecting member 220 supports a mounting mechanism for supporting an optic device such as, but not limited to, a camera C, an optical scope OS. The mounting mechanism can be any suitable mechanism such as a pan-and-tilt mechanism 400.

The pan-and-tilt mechanism 400 is commercially available as a single unit from numerous suppliers throughout the world. Because such pan-and-tilt mechanisms are widely available and are sold as single units, details of how such mechanisms are formed and operate are not discussed herein. Nonetheless, U.S. Pat. No. 4,763,151 issued on Aug. 9, 1988 issued to inventor Joseph K. Klinger and the disclosure of which is hereby incorporated herein in its entirety by reference. This patent discloses a pan-and-tilt mechanism in which a locking mechanism locks the platform member against pivotal movement about both of the tilting axes by operation of a single knob. Other types of pan-and-tilt mechanisms may be used instead, and such mechanisms can use different constructions such as use of ball-and-socket connections instead of that shown in the Klinger patent. All such prior art constructions which may be used to obtain the same pan-and-tilt results as those of the Klinger patent, are contemplated as being within the scope of the present invention.

A follower member 260 is carried by the follower guide post 200, and is manually movable toward and away from the first end 160 of the main support bracket 120. More specifically, the follower member 260 is carried at one end 306 of threaded member 300 which passes through the follower guide post 200 and is supported thereby. A knob 310 is fixed at an opposite end 308 of the threaded member 300 for manual actuation, whereby rotation in one direction of knob 310 causes threaded member 300 to move towards first end 160, and rotation in the other direction of knob 310 causes threaded member 300 to move away from first end 160. The following member 260 is located below the lower surface 148, which serves to prevent the following member 260 from rotating when the threaded member 300 is rotated by knob 310. The follower member 260 and first end 160 of the main support bracket 120 collectively function as a clamping mechanism thereby allowing a user to secure first end 160 of the main support bracket to a suitable support (not shown in FIG. 1) such as for example: a garden gate, a frame or robust part of a hunter's observation hide, a frame of a hunting blind, a wooden post. Thus, the follower member 260 is urged toward the first end 160 of the main support bracket 120 by rotation of the threaded member 300 to press against, for example, a frame of a hunting blind or other support beam, such as a pickup truck bed wall or a wall of a boat, to secure the optic support arm 100 thereto. Resilient pads P4 and P5 are optionally disposed on one surface of the follower member 260, and a resilient pad P3 is optionally disposed on a side of the first end 160 of the main support bracket 120 facing the follower member 260, so that there is little or no damage caused by the optic support arm 100 when secured to a suitable support such as the frame of the hunting blind, a window, a door of a vehicle, or any suitable support beam.

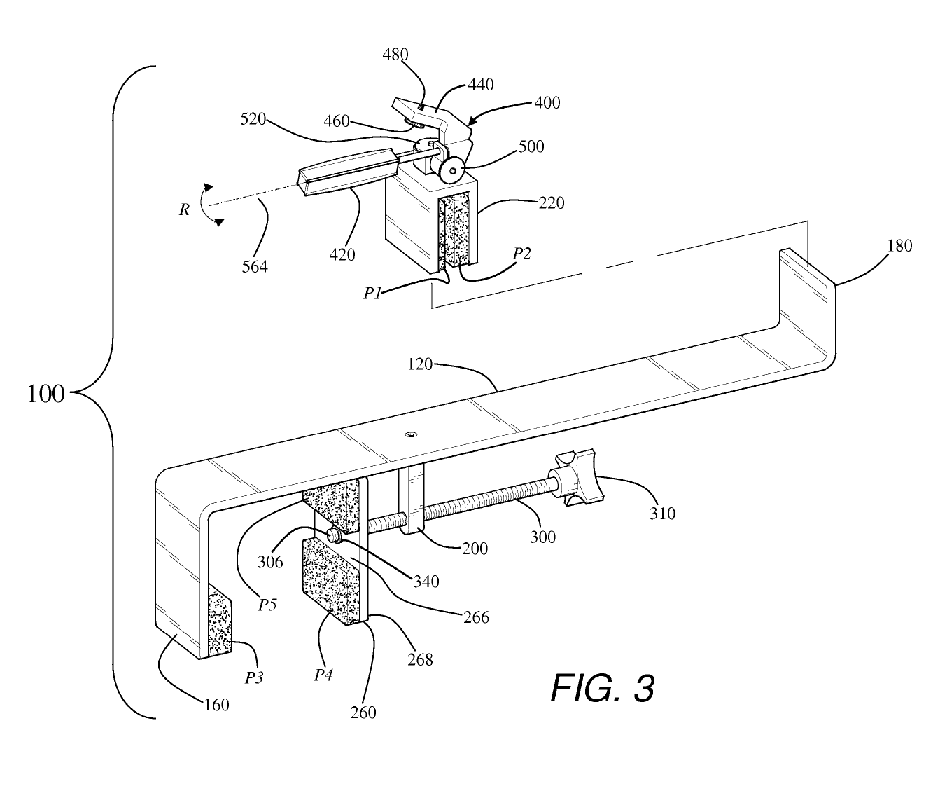

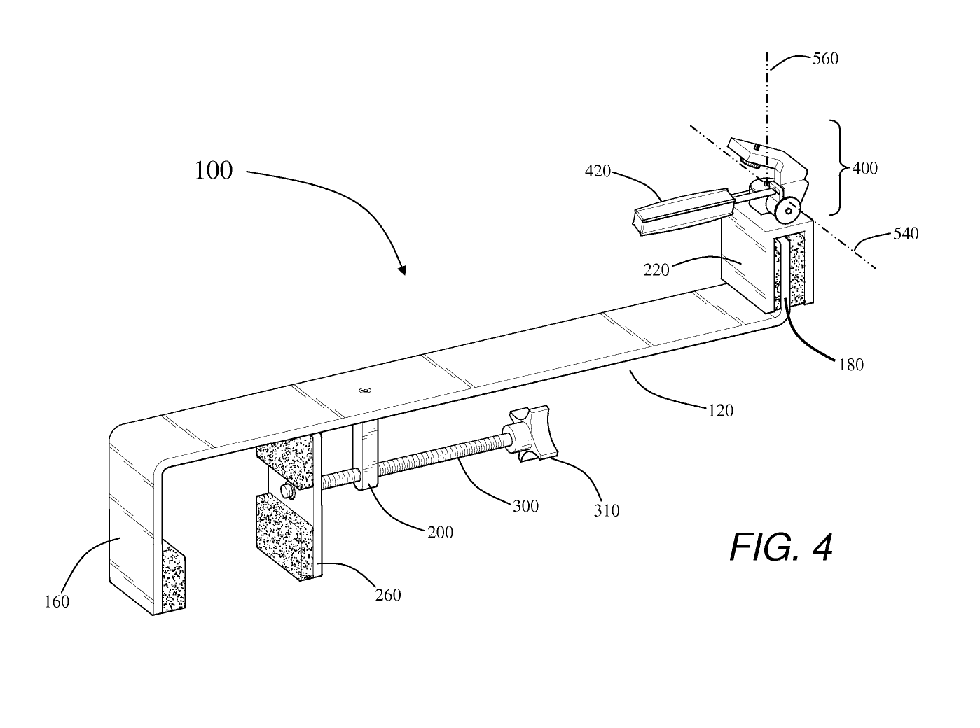

The pan-and-tilt mechanism 400 supported by the U-shaped connecting member 220 is a conventional type of commercially available mechanism. The pan-and-tilt mechanism 400 carries a mount surface 440 for detachably mounting optics such as a camera C (see FIG. 1) or spotting scope OS (see FIG. 2). The pan-and-tilt mechanism 400 includes a frictional bearing mount which is controlled by a rotation of a control handle 420 about its long axis (the rotational directions being shown by the double-headed arrow R in FIG. 3) to secure or release movement of the pan-and-tilt mechanism 400 along both of two mutually perpendicular axes 540 and 560 about its long axis 564 (see FIG. 4), and thereby enable movement of the mount surface 440.

In use, the control handle 420 is rotated in one rotational direction to a release position to release the pan-and-tilt mechanism 400 so that the camera C or spotting scope OS, or other optics, can be moved freely about the two mutually perpendicular axes 540 and 560, so that it can be aimed. When the camera C or spotting scope OS, or other optics, has been aimed, the control handle 420 is rotated in an opposite rotational direction to a securement position. In the securement position, movement of the mount surface 440 is prevented, and the camera C or spotting scope OS will remain aimed in the selected direction.

It is contemplated that the materials used in the construction of the present invention can include steel, iron, brass, bronze, aluminum, or plastic. The resilient pads described hereinabove and also hereunder are contemplated as being composed of rubber or a plastic material capable of being resiliently deformed. The selection of suitable materials is within the ambit of anyone skilled in the support arts. The dimensions of optic support arm 100 and its constituent parts can be varied depending on anticipated use and all such variations are contemplated as being within the scope of the present invention.

FIG. 2 is an environmental perspective view of the optic support arm 100, supporting a camera C shown in phantom outline.

FIG. 3 is an assembly view of the optic support arm 100 of FIG. 1, showing the pan-and-tilt mechanism 400 and its supporting U-shaped connecting member 220 separated from the main support bracket 120. As seen in this view, the threaded member 300 has free end 306. The mount surface 440 has a threaded fastener 460 with the threaded fastener's end 480 projecting therethrough for securement of an optical component such as, but not limited to, a camera C or spotting scope OS, as is conventional in the optical arts. Also as seen in FIG. 3, the pan-and-tilt mechanism 400 includes a first support portion 500 supporting pivotal rotation about a first axis and a second support portion 520 supporting pivotal rotation about a second axis, the first and second axes being mutually perpendicular to each other.

FIG. 4 is an environmental perspective view of the optic support arm 100 of FIG. 3 in an assembled condition, and showing the two mutually perpendicular axes of rotation 540 and 560 of the pan-and-tilt mechanism 400.

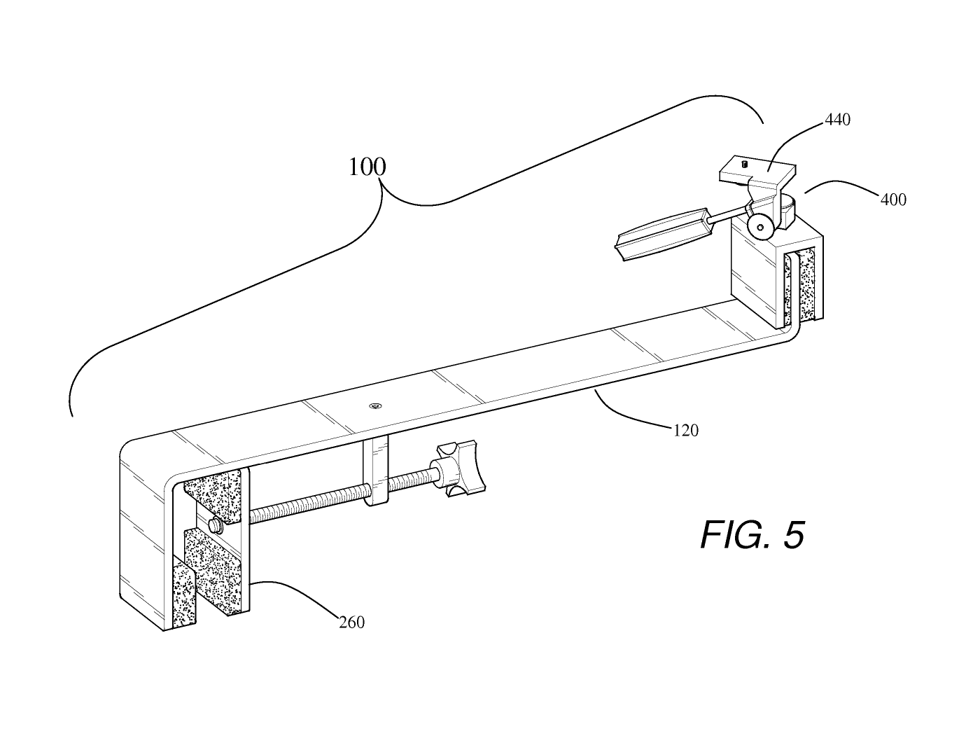

FIG. 5 is an environmental perspective view of the optic support arm 100 of FIG. 4, depicting the pan-and-tilt mechanism 400 in a slightly changed position, and showing the follower member 260 in a more closed position such as it would be in when it is secured to a frame member of a hunting blind, or other support wall or support beam.

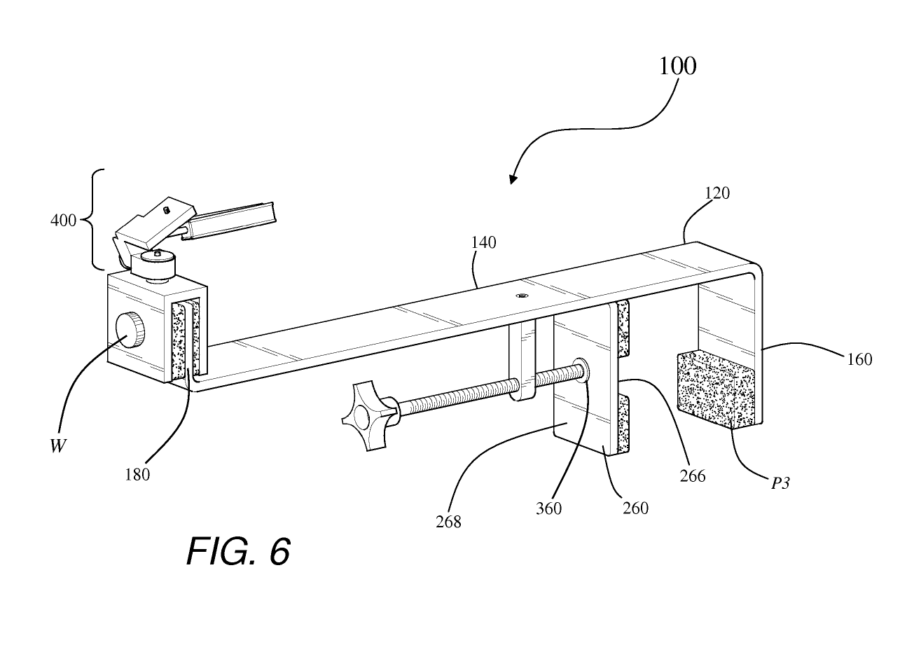

FIG. 6 is an environmental perspective view of the optic support arm 100 of FIG. 4, viewed from a direction showing another side of the pan-and-tilt mechanism 400 in which a manually operable thumbwheel W is shown.

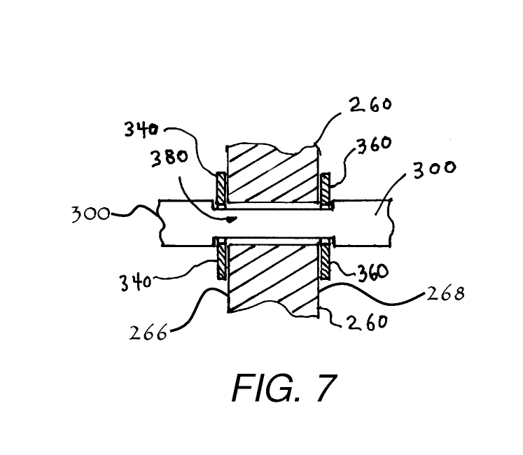

FIG. 7 is a schematic side view, partially in section, depicting securement of the follower member 260 to the threaded member 300 by retaining members 340 and 360 (also shown in FIGS. 3 and 6) disposed on opposite sides 266 and 268 of the follower member 260, respectively. The threaded member 300 has a reduced diameter portion 380 (e.g., lacks thread) disposed between the retaining members 340 and 360 so that the retaining members 340 and 360 do not slide along the threaded member 300 but instead serve to retain the follower member 260 therebetween.

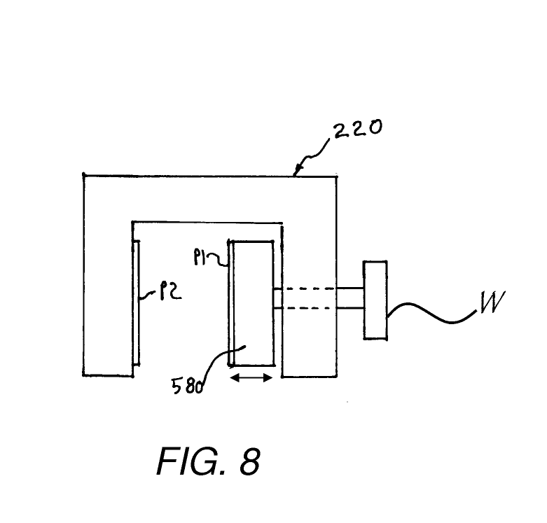

FIG. 8 is a schematic side view depicting the operation of a securement plate 580 of the U-shaped connecting member 220 for securing the U-shaped connecting member 220 to the second end 180 of the main support bracket 120 (e.g., see FIG. 1). A thumbwheel W is connected to the securement plate 580 by a threaded member (shown in dashed lines in FIG. 8), such that rotation of the thumbwheel W causes linear movement of the securement plate 580. A resilient pad P1 is shown fixedly attached to the securement plate 580. A resilient pad P2 is secured to a facing leg of the U-shaped connecting member 220 and is disposed in facing relation to the pad P1, so that actuation of the thumbwheel W secures or releases the U-shaped connecting member 220 from the second end 180 of the main support bracket 120.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. An optic support arm, comprising:
a main support bracket having a first end and a second end;
a follower guide post having a threaded bore therethrough;
an elongated threaded member in threaded engagement with the threaded bore of the follower guide post, such that rotation of the threaded member causes linear movement of the threaded member relative to the main support bracket;
a follower member connected at one end of the threaded member, and carried by the threaded member during linear movement of the threaded member in a direction toward or away from the first end of the main support bracket for releasably engaging a support member between the follower member and the first end of the main support bracket;
a connecting member releasably connectable to the second end of the main support bracket; and
a mounting mechanism, wherein the connecting member supports the mounting mechanism.

2. An optic support arm as claimed in claim 1, wherein the connecting member is a U-shaped body, wherein the second end of the main support bracket is releasably received within the interior portion of the U-shaped body.

3. An optic support arm as claimed in claim 2, wherein the connecting member includes a plate disposed between opposed legs of the U-shaped body and mounted for movement between the opposed legs on an end of a driving member.

4. An optic support arm as claimed in claim 3, wherein the driving member is a threaded rod passing through one leg of the U-shaped connecting member and in threaded engagement therewith, wherein a manually operable thumbwheel disposed on a free end of the threaded rod which is disposed on the outside of the U-shaped connecting member, and wherein rotation of the thumbwheel causes movement of the plate to engage or release the second end of the main support bracket from the U-shaped connecting member.

5. An optic support arm as claimed in claim 1, wherein the mounting mechanism includes a mount surface, a movable mechanism carrying the mount surface, and a control handle for selectively releasing or securing the movable mechanism.

6. An optic support arm as claimed in claim 5, wherein the mounting mechanism is a pan-and-tilt mechanism capable of independent movement about both of two mutually perpendicular axes of rotation.

7. An optic support arm as claimed in claim 3, further comprising a resilient pad on an interior surfaces of one leg of the U-shaped connecting member, and another resilient pad on a facing surface of the plate mounted for movement between the legs of the U-shaped connecting member.

8. An optic support arm as claimed in claim 1, wherein the mounting mechanism supports a camera.

9. An optic support arm as claimed in claim 1, wherein the mounting mechanism supports a spotting scope.

10. An optic support arm for support from a frame of a hunting blind, duck blind, or wildlife blind, comprising:
a main support bracket having a first end and a second end;
a follower guide post having a threaded bore therethrough;
an elongated threaded member in threaded engagement with the threaded bore of the follower guide post, such that rotation of the threaded member causes linear movement of the threaded member relative to the main support bracket;
a follower member connected at one end of the threaded member, and carried by the threaded member during linear movement of the threaded member in a direction toward or away from the first end of the main support bracket for releasably engaging a support member between the follower member and the first end of the main support bracket; and
a connecting member releasably connectable to the second end of the main support bracket; and
a mounting mechanism, wherein the connecting member supports the mounting mechanism.

11. An optic support arm as claimed in claim 10, wherein the mounting mechanism supports a camera.

12. An optic support arm as claimed in claim 10, wherein the mounting mechanism supports a spotting scope.

13. An optic support arm, comprising:
a main support bracket having a first end and a second end;
a follower guide post having a threaded bore therethrough;
an elongated threaded member in threaded engagement with the threaded bore of the follower guide post, such that rotation of the threaded member causes linear movement of the threaded member relative to the main support bracket;
a follower member connected at one end of the threaded member, and carried by the threaded member during linear movement of the threaded member in a direction toward or away from the first end of the main support bracket for releasably engaging a support member between the follower member and the first end of the main support bracket; and
a connecting member releasably connectable to the second end of the main support bracket, the connecting member having a mounting mechanism for supporting an optic device,
wherein the connecting member is a U-shaped body, wherein the second end of the main support bracket is releasably received within the interior portion of the U-shaped body; and
wherein the connecting member includes a plate disposed between opposed legs of the U-shaped body and mounted for movement between the opposed legs on an end of a driving member,
wherein the driving member is a threaded rod passing through one leg of the U-shaped connecting member and in threaded engagement therewith; and a manually operable thumbwheel disposed on a free end of the threaded rod which is disposed on the outside of the U-shaped connecting member; and wherein rotation of the thumbwheel causes movement of the plate to engage or release the second end of the main support bracket from the U-shaped connecting member, and
wherein the mounting mechanism includes a mount surface, a movable mechanism carrying the mount surface, and a control handle for selectively releasing or securing the movable mechanism.

14. An optic support arm as claimed in claim 13, wherein the mounting mechanism supports a camera.

15. An optic support arm as claimed in claim 13, wherein the mounting mechanism supports a spotting scope.

16. An optic support arm, comprising:
a main support bracket having first and second opposite ends and an intermediate support portion therebetween, wherein the intermediate support portion defines a generally elongated planar structure in the horizontal plane with lower and upper surfaces, wherein the first and second opposite ends respectively define first and second L-shaped brackets, wherein the first and second L-shaped brackets respectively face downwards and upwards in the vertical plane;
a follower guide post having a threaded bore therethrough, wherein the follower guide post is attached to the lower surface of the intermediate support portion and is set in a perpendicular plane with respect to the lower surface of the intermediate support;
an elongated threaded member in threaded engagement with the threaded bore of the follower guide post, such that rotation of the threaded member causes linear movement of the threaded member relative to the main support bracket;
a follower member connected at one end of the threaded member, and carried by the threaded member during linear movement of the threaded member in a direction toward or away from the first end of the main support bracket whereby the follower member and first end of the main support bracket collectively function as a clamping mechanism; and
a connecting member releasably connectable to the second end of the main support bracket; and
a mounting mechanism, wherein the connecting member supports the mounting mechanism.

17. An optic support arm as claimed in claim 16, wherein the mounting mechanism supports a camera.

18. An optic support arm as claimed in claim 16, wherein the mounting mechanism supports a spotting scope.
